(19) United States
(12) Patent Application Publication
(10) Pub. No.: US 2010/0224314 A1
(43) Pub. Date: Sep. 9, 2010

(54) LAMINATING ROLL, APPARATUS FOR PRODUCING METAL SHEET COATED WITH ORGANIC RESIN, AND PROCESS FOR PRODUCING METAL SHEET COATED WITH ORGANIC RESIN

(75) Inventors: Takuji Nakamura, Yamaguchi (JP); Hiroshi Inazawa, Yamaguchi (JP); Norimasa Maida, Yamaguchi (JP); Yasuhiro Matsubara, Yamaguchi (JP)

Correspondence Address: BROWDY AND NEIMARK, P.L.L.C.;624 NINTH STREET, NW, SUITE 300, WASHINGTON, DC, 20001-5303, US

(73) Assignee: TOYO KOHAN CO., LTD., Tokyo (JP)

(21) Appl. No.: 11/993,600

(22) PCT Filed: Jun. 20, 2006
(86) PCT No.: PCT/JP2006/312364

§ 371 Date: May 24, 2010

(30) Foreign Application Priority Data
Jun. 23, 2005 (JP) 2005-182782

(51) Int. Cl. B29C 47/02; B28B 19/00

(52) U.S. Cl. 156/244.27; 156/390

(57) ABSTRACT

The present invention aims at the continuous and stable production of an organic-resin-coated metal sheet in producing the organic-resin-coated metal sheet by an extrusion method using a laminating roll which can prevent resin portions (ear portions) protruding from the metal sheet being wound around shaft portions of the laminating roll. Using a laminating roll in which a width (A) of a region thereof coated with a lining material satisfies a relationship of 0≦A−B≦20 mm with respect to a width (B) of the metal sheet, a thermally melted organic resin is extruded and is applied to the metal sheet such that end portions of the organic resin in the widthwise direction protrude from outer portions of the laminating roll applied with the lining material, and the resin portions in a semi-molten state which protrude from respective edges of the metal sheet are removed by press-cutting.

Laminating roll, apparatus for producing organic-resin-coated metal sheet and method for producing organic-resin-coated metal sheet

### TECHNICAL FIELD

The present invention relates to a laminating roll used in the production of an organic-resin-coated metal sheet by an extrusion method, and an apparatus for producing an organic-resin-coated metal sheet, and a method for producing an organic-resin-coated metal sheet using such a laminating roll.

### BACKGROUND ART

An organic-resin-coated metal sheet coated with a film made of a thermoplastic resin is produced by discharging and extruding a resin thermally melted in the inside of the extruder from a T-die to a metal sheet thus applying the resin to the metal sheet by coating. In manufacturing the organic-resin-coated metal sheet by such an extrusion method, the molten resin in a film shape discharged from the T-die possesses, as one characteristic of the molten resin of the high viscosity, a thickness which is larger at both end portions thereof than at a center portion thereof.

Accordingly, when the molten resin in a film shape is extruded to the metal sheet, a whole area of the metal sheet in the widthwise direction is covered with a portion of the molten resin having a uniform thickness, and portions of the molten resin having a thickness at both ends thereof larger than the thickness of the center portion of the molten resin are extruded such that the portions of the molten resin portion at both ends protrude to the outside of the metal sheet in the widthwise direction and, thereafter, the protruding portions are removed.

As a method for removing such both end portions in the widthwise direction of the resin film, for example, a trimming method has been proposed (see patent document 1, for example). In this method, as shown in FIG. 1 and FIG. 2, a molten resin 3 is extruded to a metal sheet 1 from a T-die 2 and, at the time of coating the metal sheet 1 with the molten resin 3 by clamping the metal sheet 1 using a pair of laminating roll 4, resin portions which 3a protrude from the metal sheet 1 in the widthwise direction (ear portions) are clamped by clip means such as endless guide belts before the resin portions are cooled and are removed by tearing.

The laminating roll 4 is, as shown in FIG. 2, made of a metal material 4b and has a hollow inner portion through which a coolant for cooling the laminating roll 4 freely flows. A surface of the laminating roll 4 is coated with a lining material 4a made of a resilient material such as silicon rubber or fluororubber or the like having heat resistance. As shown in FIG. 2 and FIG. 3, when a width of the lining material 4a is set larger than a whole width of the molten resin extruded from the T-die, the resin portions which protrude from the metal sheet 1 (ear portions) 3a are wound around the laminating roll 4 thus making the continuous product ion of an organic-resin-coated metal sheet impossible.

As the prior-art literature information on the present application, the following is known.

Patent document 1: JP-A-2002-127099

### DISCLOSURE OF THE INVENTION

### Tasks to be Solved by the Invention

It is an object of the present invention to provide a technique which can continuously and stably produce an organic-resin-coated metal sheet using a laminating roll which prevents resin portions protruding from a metal sheet (ear portions) from being wound around shaft portions of the laminating roll at the time of manufacturing the organic-resin-coated metal sheet by an extrusion method.

### Means for Solving the Tasks

A laminating roll according to the present invention which can overcome the above-mentioned drawback is A laminating roll for producing an organic-resin-coated metal sheet produced by directly extruding a thermally melted organic resin in a film shape to a continuously-supplied elongated strip-shaped metal sheet from a T-die and by bringing the extruded organic resin into contact with the metal sheet, and by pressure-bonding the organic resin to the metal sheet by clamping the metal sheet and the organic res in using a pair of laminating rolls, wherein the laminating roll is made of a metal material, has a hollow inner portion through which a coolant for cooling the laminating roll freely flows, and forms a lining material made of a resilient material on a surface thereof, and a width (A) of a region of the laminating roll on which the lining material is formed is set to a value which satisfies a relationship of 0≦A−B≦20 mm with respect to a width (B) of the metal sheet (claim 1).

In the above-mentioned laminating roll (claim 1), the metal material forming the laminating roll is exposed on portions of the laminating roll arranged outside the region of the laminating roll on which the lining material is formed (claim 2).

Further, an apparatus for producing an organic-resin-coated metal sheet according to the present invention (claim 3) is an apparatus for producing an organic-resin-coated metal sheet which is characterized by using the above-mentioned laminating roll (claim 1 or 2)

Still further, in the above-mentioned apparatus for producing an organic-resin-coated metal sheet (claim 3), a steering means for the metal sheet is arranged directly in front of the laminating roll, and the metal sheet is steered to prevent the metal sheet from protruding from the region of the laminating roll on which the lining material is formed using the steering means (claim 4).

Further, a method for producing an organic-resin-coated metal sheet according to the present invention is a method for producing an organic-resin-coated metal sheet which is characterized in that, using the apparatus for producing an organic-resin-coated metal sheet described claim 3 or 4, a thermally melted organic resin is extruded and applied to the metal sheet in a state that end portions of the organic resin in the widthwise direction protrude from portions of the laminating roll outside the applied lining material and, thereafter, the resin portions protruding from both end portions of the metal sheet are cut and removed by pushing (claim 5).

### BRIEF EXPLANATION OF DRAWINGS

FIG. 1 is a schematic side view showing one example of a method for producing an organic-resin-coated metal sheet using a conventional extrusion method.

FIG. 2 is a schematic front view showing an apparatus for producing an organic-resin-coated metal sheet which uses the conventional extrusion method shown in FIG. 1.

FIG. 3 is a schematic front view showing a method for producing an organic-resin-coated metal sheet using one example of a conventional laminating roll.

FIG. 4 is a schematic front view showing a method for producing an organic-resin-coated metal sheet using one example of a laminating roll according to the present invention.

FIG. 5 is a schematic front view showing a method for producing an organic-resin-coated metal sheet using another example of a laminating roll according to the present invention.

FIG. 6 is a schematic front view showing a method for producing an organic-resin-coated metal sheet using another example of a laminating roll according to the present invention.

FIG. 7 is a schematic front view showing a method for producing an organic-resin-coated metal sheet using another example of a laminating roll according to the present invention.

FIG. 8 is a schematic side view showing one example of a method for producing an organic-resin-coated metal sheet according to the present invention.

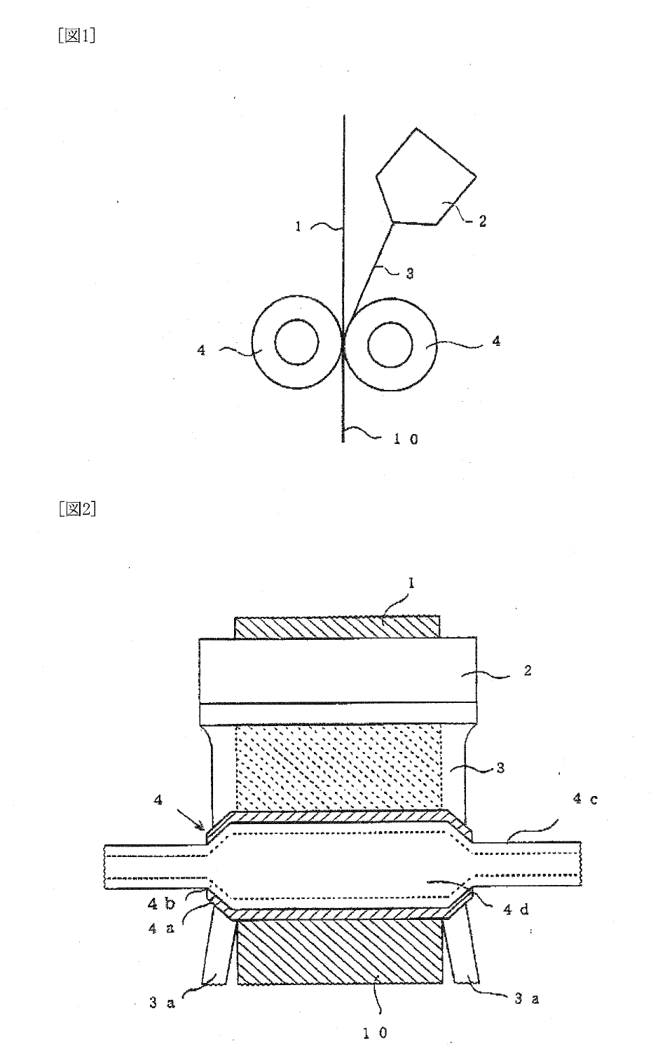

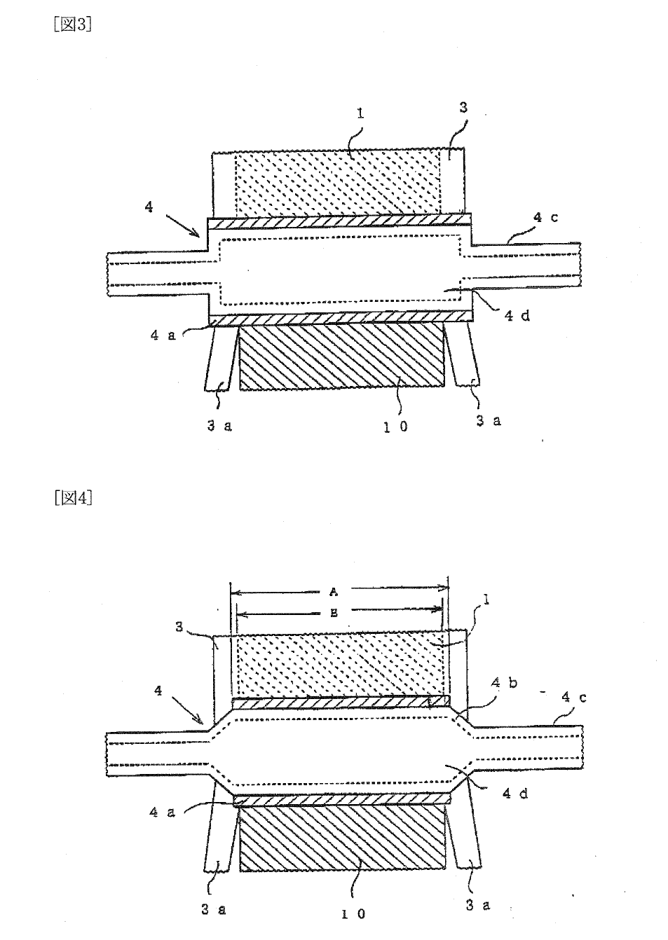

Here, in the drawings , symbol 1 indicates a metal sheet, symbol 2 indicates a T-die, symbol 3 indicates an organic resin, symbol 3a indicates resin portions protruding from the metal sheet 1 (ear portions), symbol 4 indicates a laminating roll, symbol 4a indicates a lining material, symbol 4b indicates a metal material, symbol 4c indicates shaft portions, symbol 4d indicates a hollow portion, symbol 7 indicates a steering means, and symbol 10 indicates an organic-resin-coated metal sheet respectively.

### Best Mode for Carrying out the Invention

Hereinafter, the present invention is explained in detail. As a resin which is applied to an organic-resin-coated metal sheet produced by using a laminating roll, an apparatus for producing an organic-resin-coated metal sheet or a method for producing an organic-resin-coated metal sheet according to the present invention, it is possible to use: a 1-alkene copolymerization resin haying 2 to 8 carbon atoms such as low-density polyethylene, medium-density polyethylene, high-density polyethylene, polypropylene, polybutene-1, polypentene-1, polyhexene-1, polyheptene-1 or polyoctene-1; a polyolefin resin essentially consisting of one, two or more kinds of copolymers selected from an ethylene-propylene copolymer, an ethylene-butene-1 copolymer, an ethylene-hexene copolymer and the like; or a polyimide resin such as 6-nylon, 6, 6-nylon and 6, 10-nylon or the like; or a polyester resin essentially consisting of, as an acid component, one, two or more kinds of acids selected from a therephthalic acid, an isophthalic acid, an orthophthalic acid, a P-β-oxyethoxy benzoic acid, a naphthalene-2, 6-dicarbon acid, a diphenoxyethane-4, 4-dicarbon acid, a dibasic character aromatic dicarboxyl acid such as 5-sodium sulfoisophthalic acid, a hexahydro terephthalic acid, an alicycle group dicarboxylic acid such as cyclohexanedicarboxylic acid, an adipic acid, a sebacic acid, an aliphatic dicarboxylic acid such as a dimmer acid, a trimellitic acid, a pyromellitic acid, a hemimellitic acid, a 1,1,2,2 -ethane tetracarboxylic acid, 1,1,2-ethane tricarboxylic acid, a 1,3,5-pentane tricarboxylic acid, a 1,2,3,4-cyclopentane tetracarboxylic acid, and a polybasic acid such as biphenyl-3 , 4, 3′, 4′-cyclopentane tetracarboxylic acid, and as one, two or more kinds of alcoholic components selected from ethylene glycol, propylene glycol, 1,4-butanediol, neopentyl glycol 1,6-hexylene glycol, diethylene glycol, triethylene glycol and a diol such as cyclohexane dimethanol, pentaerythritol, glycerol, trimethylolpropane, 1,2,6-hexane triol, sorbitol and polyalcohol such as 1,1,4,4 -tetrakis (hydroxyl methyl) cyclohexane.

As the metal sheet, a plated steel sheet to which zinc, aluminum, tin, nickel, copper, magnesium or an alloy made of two or more kinds of metals selected from these metals is plated, a surface-treated steel plate to which electrolytic chromic acid treatment or non-chromic surface treatment is applied, the above-mentioned plated steel sheet to which such surface treatment is applied, an aluminum alloy sheet, a surface-treated aluminum alloy sheet to which the above-mentioned surface treatment, alumite treatment or the like is applied can be used.

Next, the laminating roll 4 of the present invention is explained. The laminating roll 4 of the present invention is, as in the case of an example shown in FIG. 4, made of the metal material 4b such as carbon steel or the like in the same manner as a usual laminating roll . An inner portion (inside) of the laminating roll 4 is made hollow including shaft portions 4c thus allowing a coolant for cooling such as water or hot water to freely flow therethrough. A lining material 4a made of resilient material having heat resistance such as silicon rubber or fluororubber is formed on a surface of the laminating roll 4. In such a constitution, the present invention is characterized by setting, as shown in FIG. 4, a width (A) of a region of the laminating roll 4 applied with the lining material 4a to a value equal to or larger than a width (B) of the metal sheet 1. In extruding the thermally melted organic resin 3 to the metal sheet 1 from the T-die and laminating the organic resin 3 to the metal sheet by clamping and pressurizing the metal sheet 1 and the organic resin 3 by a pair of laminating rolls 4, to apply a uniform pressuring force to the whole metal sheet 1 in the widthwise direction, it is necessary to set the width of the lining material 4a made of the resilient material equal to at least the width of the metal sheet 1. However, according to the present invention, the elongated strip-shaped metal sheet 1 is continuously supplied from a supplying means such as an uncoiler not shown in the drawing by way of a plurality of transport means such as guide rolls not shown in the drawing and hence, the metal sheet 1 is transported while being unavoidably relatively fluctuated with respect to the fixed position of the laminating roll 4 in the widthwise direction in an actual operation. Accordingly, by expecting the occurrence of fluctuation of the metal sheet 1 due to the transport of the metal sheet 1 with respect to the relative position of the laminating roll 4 in the widthwise direction, it is preferable to set the width (A) of the lining material 4a of the laminating roll larger than the width (B) of the metal sheet 1. Although a setting quantity of the width (A) of the lining material 4a may depend on the accuracy of transfer of the metal sheet 1, it is preferable to set the width (A) of the lining material 4a as small as possible from a viewpoint of miniaturizing extra resin portions (ear portions) 3a which are removed after coating the lining material 4a to the metal sheet 1. According to the present invention, it is preferable to set the width (A) of the applied lining material 4a to a value which satisfies a relationship of 0≦A−B≦20 mm with respect to a width (B) of the metal sheet 1.

Further, to make the width (A) of the portion of the laminating roll 4 coated with the lining material 4a with respect to the width (B) of the metal sheet 1 fall within the above-mentioned range, the apparatus for producing an organic-resin-coated metal sheet may be configured such that, as shown in FIG. 8, directly in front of the laminating roll 4 which brings the thermally melted organic resin 3 extruded from the T die 2 into contact with the metal sheet 1, a steering means 7 such as a steering roll is arranged so that the metal sheet 1 is transported thus preventing the metal sheet 1 from protruding from the portion of the laminating roll 4 to which the lining material 4a is applied.

By setting the applied width (A) of the lining material 4a on the laminating roll 4 equal to or more than the width (B) of the metal sheet 1, and by transporting the metal sheet 1 while steering the metal sheet 1 immediately before the organic resin 3 is brought into contact with the metal sheet 1 such that the metal sheet 1 does not protrude from portions of the lining material 4a on the laminating roll 4, the thermally melted resin 3 which is extruded to the metal sheet 1 receives a uniform pressurizing force over the whole metal sheet 1 in the widthwise direction and, at the same time, the organic resin is applied while suppressing the generation of extra organic resin. Here, with respect to the thermally melted organic resin 3, the portion applied to the metal sheet 1 is brought into contact with the metal sheet 1 cooled down to an appropriate temperature by the laminating roll 4 and hence, the portion of the organic resin 3 is cooled and solidified. On the other hand, the thermally melted resin portions (ear portions) 3a which protrude from both ends of the metal sheet 1 in the widthwise direction are brought into contact with the lining material 4a of the laminating roll 4. Although the inside of the laminating roll 4 is made hollow including the shaft portions 4c and the coolant flows in the inside of the laminating roll 4 to set a temperature of the laminating roll 4 to a value equal to or lower than a melting temperature of the molten resin 3, the lining material 4a is continuously brought into contact with the molten resin 3 and hence, the lining material 4a is heated. Further, the heat conductivity of the lining material 4a is far smaller than the heat conductivity of metal and hence, it is not possible to sufficiently acquire a cooling effect attributed to the coolant which flows in the hollow portion 4d of the laminating roll 4 whereby the lining material 4a exhibits a temperature which is far higher than the temperature of the metal sheet 1 and is close to the melting temperature of the resin at high temperature. That is, the protruding resin portions (ear portions) 3a which are in contact with the lining material 4a are not completely solidified and are in a semi-molten state. Accordingly, the resin 3a in a semi-molten state is adhered to the lining material 4a and is wound around the laminating roll 4 thus making it difficult to continuously perform the laminating operation.

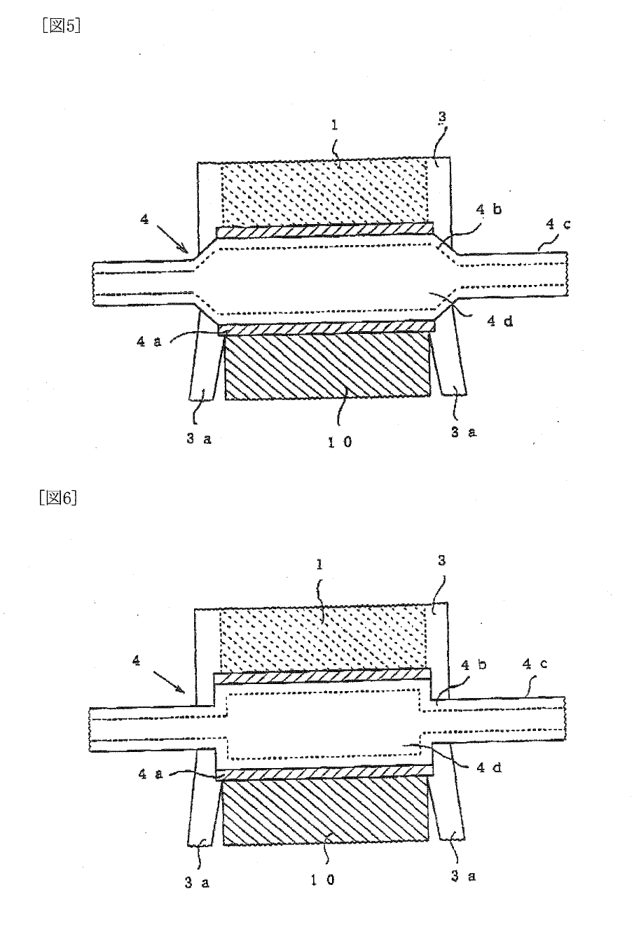

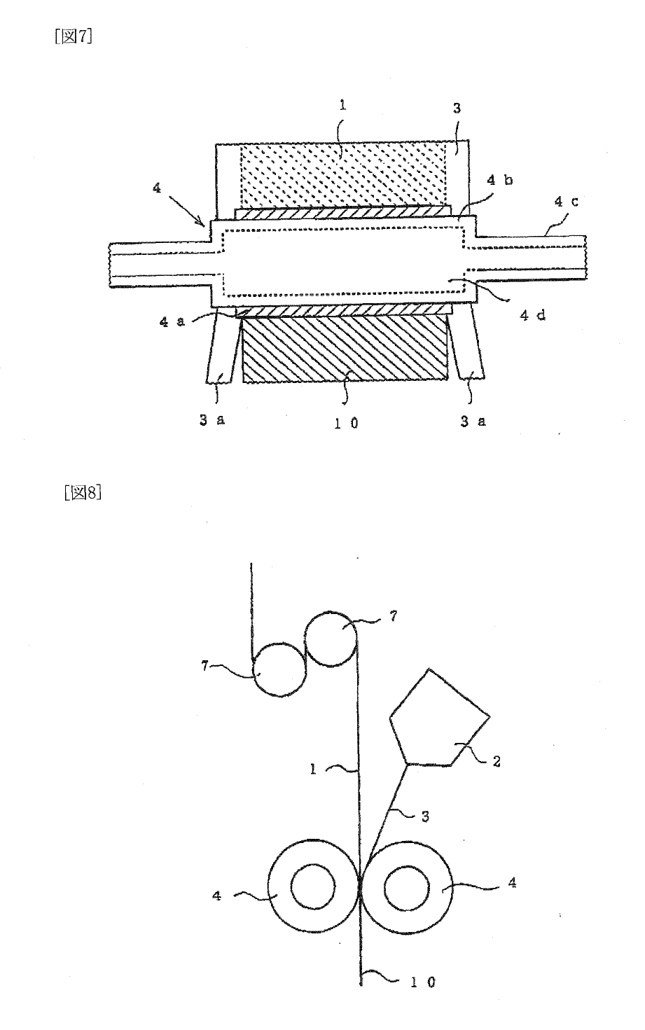

Accordingly, in the present invention, as shown in FIG. 4 to FIG. 7, the portions of the laminating roll 4 outside the applied lining material 4a are exposed, and the resin portions (ear portions) 3a in a semi-molten state which protrude from the lining material 4a are brought into contact with and are solidified by the exposed portions of the metal material 4b including or not including the shaft portions 4c which are set to the temperature equal to or below the melting temperature of the molten resin by allowing the coolant to flow in the hollow inner portion of the laminating roll. Further, by clamping the solidified resin portions (ear portions) 3a by the laminating roll 4 and end portions of the metal sheet 1, the protruding resin portions (ear portions) 3a are cut by pushing by end portions of the metal sheet 1 and hence, it is possible to lead the resin portions (ear portions) 3a cut by pushing to the a winding means such as a winding roller not shown in the drawing so as to continuously remove the resin portions. On the other hand, the metal sheet 1 can be led and wound by a winding means such as a winding roll not shown in the drawing as the resin coated metal sheet 10 coated with the resin to end portions thereof with no extra resin portions (ear portions) 3a remaining at both ends in the widthwise direction.

### INDUSTRIAL APPLICABILITY

The laminating roll of the present invention is made of the metal material, the inner portion of the laminating roll is made hollow to allow the coolant for cooling to flow freely thus cooling the metal sheet by way of the lining material made of resilient material applied to the surface of the metal sheet whereby the molten resin is cooled and solidified. Further, since the width (A) of the lining material is set to a value which satisfies the relationship of 0≦A−B≦20 mm with respect to the width (B) of the metal sheet 1 and hence, the pressurizing force of the laminating roll is uniformly applied to the whole surface of the metal sheet. Further, the resin portions protruding from both sides of the metal sheet (ear portions) are brought into contact with the exposed portions of the metal material forming the laminating roll outside the applied lining material and hence, the exposed resin portions (ear portions) are cooled and solidified whereby there is no possibility that the ear portions are wound around the laminating roll.

Further, in the apparatus for producing an organic-resin-coated metal sheet of the present invention, the steering means such as the steering roll is arranged directly in front of the laminating roll where the thermally melted organic resin extruded from the T -die is brought into contact with the metal sheet. Accordingly, the metal sheet can be steered such that the metal sheet does not protrude from the portions of the laminating roll coated with the lining material and hence, the pressurizing force of the laminating roll is uniformly applied to the whole surface of the metal sheet.

Further, in the method for producing an organic-resin-coated metal sheet of the present invention, the thermally melted organic resin is applied to the metal sheet by extruding the thermally melted organic resin such that the end portions of the organic resin in the widthwise direction protrude from the portions of the laminating roll outside the applied lining material . Accordingly, the resin portions (ear portions) in a semi-molten state protruding from the portions of the laminating roll outside the applied lining material are brought into contact with the exposed portions of the metal material forming the laminating roll and are cooled and solidified and hence, there is no possibility that the ear portions are wound around the laminating roll whereby the solidified resin portions, that is, the ear portions which protrude from both end portions of the metal sheet can be continuously cut and removed by pushing. That is, there is no possibility that the resin portions (ear portions) protruding from the metal sheet are wound around the laminating roll and hence, the organic-resin-coated metal sheet can be produced continuously and stably.

1. A laminating roll for producing an organic-resin-coated metal sheet produced by directly extruding a thermally melted organic resin in a film shape to a continuously-supplied elongated strip-shaped metal sheet from a T-die and by bringing the extruded organic resin into contact with the metal sheet, and by pressure-bonding the organic resin to the metal sheet by clamping the metal sheet and the organic resin using a pair of laminating rolls, wherein the laminating roll is made of a metal material, has a hollow inner portion through which a coolant for cooling the laminating roll freely flows, and forms a lining material made of a resilient material on a surface thereof, and a width (A) of a region of the laminating roll on which the lining material is formed is set to a value which satisfies a relationship of 0≦A−B≦20 mm with respect to a width (B) of the metal sheet.

2. A laminating roll according to claim 1, wherein the metal material forming the laminating roll is exposed on portions of the laminating roll arranged outside the region of the laminating roll on which the lining material is formed.

3. An apparatus for producing an organic-resin-coated metal sheet being characterized by using the laminating roll described in claim 1.

4. A method for producing an organic-resin-coated metal sheet according to claim 3, wherein a steering means for the metal sheet is arranged directly in front of the laminating roll, and the metal sheet is steered such that the metal sheet does not protrude from the region of the laminating roll on which the lining material is formed using the steering means.

5. A method for producing an organic-resin-coated metal sheet being characterized that, using the apparatus for producing an organic-resin-coated metal sheet called for in claim 3, a thermally melted organic resin is extruded and applied to the metal sheet by coating in a state that end portions of the organic resin in the widthwise direction protrude from portions of the laminating roll outside the applied lining material and, thereafter, the resin portions in a semi-molten state protruding from both end portions of the metal sheet is cut and removed by pushing.
